(19) United States
(12) Patent Application Publication
(10) Pub. No.: US 2010/0045037 A1
(43) Pub. Date: Feb. 25, 2010

(54) POWER GENERATION SYSTEM USING WIND TURBINES

(75) Inventors: James ShihFu Shiao, Stow, OH (US); Albert ShihYung Shiao, Stow, OH (US)

Correspondence Address: Emerson, Thomson & Bennett, LLC, 777 W. Market Street, Akron, OH, 44303, US

(73) Assignee: DAW SHIEN SCIENTIFIC RESEARCH AND DEVELOPMENT, INC., Stow, OH (US)

(21) Appl. No.: 12/263,775

(22) Filed: Nov. 3, 2008

Related U.S. Application Data
(63) Continuation-in-part of application No. 12/195,623, filed on Aug. 21, 2008.

(51) Int. Cl. F03D 9/00; F03D 7/02; F03D 11/02

(52) U.S. Cl. 290/44; 416/42; 416/170 R; 416/241 R

(57) ABSTRACT

A new wind turbines system extracts dynamic energy from ambient sources and generates power with high efficiency. The less-fluctuated slower-speed turbines have a high-ratio gear reducer to increase the high-power DC generator's speed. An analog/digital voltage converting sampler, a digital signal processor, a power battery charging/discharging regulator, and a power output in steady and continuous states meet its power generation safety and security requirements, which may produce power at about 50% efficiency. A power regulator stabilizes the fluctuations of the incoming power and regularizes its power outputs in steady and continuous states. A high ratio gear reducer (1:100=1:10×10 in two stages) increases its generator's speed and meets power generation requirements. The lower pole of larger blades' surface area using light-weight nylon fabric single-surfaced blade layer with strong angled strut support structure more efficiently converts power into electricity, and their conservation processes cut installation capital and maintenance costs.

### CROSS-REFERENCE TO RELATED APPLICATIONS

This patent application is a continuation-in-part of U.S. Ser. No. 12/195,623 entitled POWER GENERATION SYSTEM USING WIND TURBINES, filed on Aug. 21, 2008, the content of which are hereby incorporated by reference.

### FIELD OF THE INVENTION

The present invention relates generally to generating electricity in steady state at ambient temperatures by using the new stronger, larger surface area, but lighter-weight wind turbines system on lower pole reacting with enough ground wind, which power is through a power generation/output regularization process to have steady output connected to the grid. This invention is more particularly to a method of using an analog/digital voltage converting sampler, a digital signal processor, a power charging/discharging regulator, and a power output in steady and continuous supplying to outside power grid, which meets its power generation safety and secured requirements.

### BACKGROUND OF THE INVENTION

In recent years, the conventional wind turbines engines have demanded higher efficiency and have used the smaller but heavier-weight blades on the higher pole and no stronger support structure from behind, which need major design changes and more advanced technology.

The conventional wind turbines engine only has low efficiency, and the conventional wind turbines' blades are required to be redesigned to have larger surface area, lighter-weight blades of stronger support frame structure behind, lower pole with more air/blade reaction surface area making-up its enough wind power, easier to build, and supplying their power generations in steady states through power charging/discharging set regulator with better reliable efficiency.

The conventional wind turbines engine and wind-mill blades are also considered to have similar process elements of a power generation, but they are called by different names. The conventional wind turbines engine runs its processes in a low efficiency through those elements of the conventional heavier blade with its reversed shape, smaller surface area, and unstable power generation system. Therefore, the conventional wind power engine process can only generate small portion from its available power.

If wind turbines blades operated with the leading edge reversed such that it becomes the new single stream-line surfaced blade, and putting the pointed tail edge to be its front leading edge of the strong support structure, then its efficiency will be even higher than the conventional wind turbines blades. If the conventional wind turbines' blades also had a larger surface area, they would generate more power than they had.

In the inventive process, the slower-speed turbines can take more wind pressure difference, extract more air/blade speed difference, and generate more power. Conventional blades need to be re-designed with more stream-lined-like, more stably rotating at a slower speed with less ball-bearing friction wornness. These slower-speed less-fluctuating turbines are connected to a high-ratio gear reducer to increase the DC generator's speed. An analog/digital voltage converting sampler, a digital signal processor, a power charging/discharging regulator, and a power output in steady and continuous states to outside power grid are also attached to the ground, which meet its power generation safety and secured requirements.

Those devices may extract fluctuated wind force from unstable fast air stream to generate more useful and stable power, continuously. They minimize the disadvantages of the conventional running turbines in a faster but with uneven and less stable ways, and minimize their ball-bearing wornness.

ΣP .Δ A_{Large}=P. [large blade area x many numbers of blades]=F_{Large} If the blade's pitch angle is 45° facing to the attacking wind:

F.(Δt)=Δ(mv)=(m.Δv); For steady state air flow and blades movement, and;

F.Δt=Δ(mv)=(mΔv)=Σρ.v.ΔA.Δt.Δv=(∫ρₐᵢᵣ.vₐᵢᵣ.2πr.dr.Δt(vₐᵢᵣ−v_{blade})sin 45°)

F.Δt=∫ρₐᵢᵣ.vₐᵢᵣ.2πr.dr.Δt(vₐᵢᵣ−2πr(rpm/60sec)) sin 45°; where v_{blade}=2πr.(rpm/60sec)

F=(Σρ.v.ΔA).Δv=∫ρ.v.2πr.dr.(vₐᵢᵣ−2πr.(rpm/60sec)). sin 45°

Torque Γ=ΣΔF.r.sin θ=ΣΔF.r.sin 90°=ΣΔF₁.r₁=ΣΔF₂.r₂ If the blade's pitch angle is 45° facing to the attacking wind:

Torque Γ=ΣΔF.r=∫₀^{R} (ρₐᵢᵣ.vₐᵢᵣ.2πr.dr.(vₐᵢᵣ−2πr.(rpm/60 sec)).(sin 45°)). r
Power produced=Σ(Δ Force F).v_{blade}; where v_{blade}=(2πr.(rpm/60 sec)
Power produced=∫₀^{R} (ρₐᵢᵣ.vₐᵢᵣ.2πr.dr.(vₐᵢᵣ−2πr.(rpm/60 sec)) sin 45°).2πr.(rpm/60 sec)
Power produced=ρₐᵢᵣ.vₐᵢᵣ.π².R³ [( 4/3) vₐᵢᵣ−2πR.(rpm/60 sec)].(rpm/60 sec). sin 45°;

Find maximum power of desired: d (power)/dR=0; d² (power)/d²R<0. For d (power)/dR=0; we get vₐᵢᵣ=(2π.R [rpm/60 sec])=v_{blade's tip}; v_{blade's tip}=vₐᵢᵣ;
Substitute vₐᵢᵣ=(2π.R [rpm/60 sec])=v_{blade's tip}; back into above equations, we get Maximum power produced=(⅔) ρₐᵢᵣ.vₐᵢᵣ.π³.R⁴ [rpm/60 sec]².( sin 45°);
While ρₐᵢᵣ=0.0012; vₐᵢᵣ=10 m/sec; R=5 m; substitute those data back into above equations, we get [rpm/60]=0.31845; rpm=19.1; and,
Maximum power produced=11.1 ton-m/sec=108,800 Newton-m/sec;
1 Newton=8.35 VA; 108,800 Newton-m/sec=908,300 VA-m/sec;

| V_{wind} | | | | 100 × rpm |
|---|---|---|---|---|
| meter/sec | Ton-m/sec | Newton-m/sec | VA-m/sec | Of Generator's |
| 10 | 11.0998 | 108,800 | 908,300 | 1910 |
| 20 | 88.7931 | 870,173 | 7,265,945 | 3820 |

where v_{blade's tip} is the same as the wind speed vₐᵢᵣ; p is the density; v is the speed; v_{blade's tip} is the blade tip's speed; R is the blade's radius; P is pressure; A is the area; Γ is the Torque.

Another advantage of these light-weight nylon fabric made single-surfaced blades with strong angle strut support frame structure behind makes these less-fluctuated slow-turbines run through in the fast and unstable air stream and generated maximum power in more stable and more efficient ways with a charging/discharging regulator mounted on the ground, and they are much easier and much cheaper to be built and maintained on the ground.

A wind power device is another example of a device, which absorbs energy at ambient temperature and perpetuates generating power from the solar energy's convective wind current for lasting.

### SUMMARY OF THE INVENTION

The present invention utilizes less-fluctuated wind turbines blades and a new power generation/output regulator together, from which this fluctuating air stream energy can be extracted out into much more stable electricity outputs through a charging/discharging regulator, and a DC/AC power converter and transformer to the outside power grid, which meets its power generation safety and secured requirements.

An advantage of the present invention is that blades weight is much lighter, more stream-lined, and more efficient than the conventional wind turbines. It just uses wind fluctuating current's energy built from the solar energy to push the larger air/blades surface-area to generate more electricity and outputs electricity in steady and continuous ways.

Another advantage of the present invention is the flexibility of the wind turbines' system process. It may use air (oxygen and nitrogen) as its working fluid, transfer energy, and extract work from the air/blade reactions, in which the blade can have single-surfaced nylon blade layer with strong angle strut supporting structure from behind. More air/blade reaction surface area, less-fluctuated, slower-blade-rotation-speed, and more stable power-generation states with its higher pressure difference (force) generated on blades are these better designs.

If the blade's pitch angle is 450 facing to the attacking wind: Minimum wind speed for blades starting to rotate: Torque Γ=∫r.dF=∫r.d(m_{blades}.a_{tangential}) and if the blades covered the surface area of 1.414 times of the whole circle:

where a_{tangential} is tangential acceleration; α is tangential angular acceleration; ρ_{blade} is the density of the blade.

If R=5 meters; ρ_{blade}=0.94; ρₐᵢᵣ=0.0012; α the angular acceleration≈0.05 rad/sec²;

blade's thickness=0.001 meter; blade's surface covered area factor≈1.414:

Torque Γ_{blade}=ΣΔF .r=∫₀^{R} (ρ_{blade}.(blade's thickness).(factor 1.414) .2πr. dr. (r.αa) .r

Torque Γ_{blade}=ΣΔF .r=∫₀^{5m} (0.94 (0.001 m). (area factor 1.414) .2πr. dr. (r.α) .r

Torque Γ_{blade}=ΣΔF_{blade}. r=1.3α=0.065; where α≈0.05 rad/sec²

For the wind power and wind torque:

Torque Γₐᵢᵣ=ΣΔFₐᵢᵣ. r=∫₀^{R} (ρₐᵢᵣ.vₐᵢᵣ.2πr. dr. (vₐᵢᵣ−2πr.(rpm/60 sec)).(sin 45°)) .r

Torque Γₐᵢᵣ=ρₐᵢᵣ.vₐᵢᵣ.π.R³ [(⅔) vₐᵢᵣ−πR. (rpm/60 sec)]. sin 45°;

While starting rotating: v_{blade}=2πr.(rpm/60 sec)≈0; substitute this stationary blade speed, 0, back into the above equation, we get

Torque Γₐᵢᵣ=(⅔) ρₐᵢᵣ.(vₐᵢᵣ)².π.R³ .sin 45°=(⅔). 0.0012.(vₐᵢᵣ)².π.(5 m)³ .sin 45°;

Torque Γₐᵢᵣ=0.22195 (vₐᵢᵣ)²>>Torque Γ_{blade}=0.065_{blade} Blades start rotating

Torque Γ=0.22195 (vₐᵢᵣ)²>>0.065_{blade}; solved for (vₐᵢᵣ)>0.54 m/sec≈1.9 km/hr

The minimum wind speed for blades ( R=5 m ) starting to rotate at: [vₐᵢᵣ>1.9 km/hr]

The present invention is a process, whose effects can generate power from the ambient temperature of solar-thermal-current fluctuating energy and also can use its stabilization electricity to cool down the surrounding temperature lower than room temperature (as by transferring heat energy into work from solar energy of using air (or oxygen and nitrogen) as its working fluid ).

This new high efficient wind turbines power generation process can use air for its working fluid by using (1) less-fluctuated slower-speed turbines attached with a high ratio gear reducer increase its generator's speed and through a power charging/discharging regulator in a much more steady way and meets its power generation requirements, continuously, and (2) it generates power by using the new analog/digital converting sampler with battery sets to regularize electricity through its power-generation/output.

This new invention provides improvements over the conventional wind turbines' engine processes. And these new larger-surface area blades can generate more power directly into DC electricity through a power-generation regulator mounted on the ground.

This new process can have the wind turbines power generation close to 50% efficiency. And use its electricity to run the air conditioner and refrigerator with higher efficiency, which may only need smaller heat transfer surface area.

This new air/wind turbines power generation process can produce power under temperatures lower than the ambient temperature. This useful wind turbines' power generation process can use air for its working fluid at low temperatures without damaging the environment (no chemical refrigerants leaking, no cooling water discharge, no thermal pollution, and no radioactive or hazardous wastes).

### BRIEF DESCRIPTION OF THE DRAWINGS

The invention may take physical forms in certain parts and arrangement of parts, embodiments of which will be described in detail in this specification and illustrated in the accompanying drawings which form a part hereof and wherein:

FIG. 1 is a schematic diagram of the conventional wind turbines' engine and its blade's cross section;

FIG. 2 is a schematic diagram of the inventive down-wind wind turbines power generation process and the less-fluctuated slower-speed turbines with a high-ratio gear reducer attached to the associate generator. And the power generation regulator is mounted on the ground;

FIG. 3 is a schematic diagram of the conventional blade's heavy and solid cross section and the new light-weight nylon fabric single-surfaced blades in the front of stronger angled strut support structure's cross section;

FIG. 4 is a schematic diagram of the new automatic hydraulic safety device to adjust the blade's pitch by the uneven and stronger wind pressure generated at the blade's rear parts, automatically;

FIG. 5 is a schematic diagram of the new analog/digital converting sampler and digital signal processor to control the algorithm of charging battery sets through various voltage levels. They also stabilize the output and regularize the input voltage to battery sets in steady and continuous ways; and,

FIG. 6 is a schematic diagram of the new power generation/output regulator mounted on the ground, which generates the electricity through battery charging/discharging arrays' and DC/AC converter's reactions.

### DETAILED DESCRIPTION

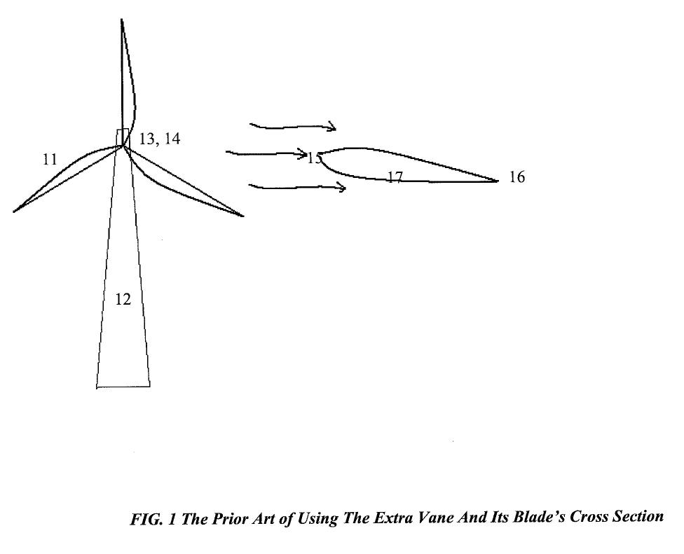

With reference now to FIG. 1, the conventional wind turbines engine process includes three propeller (narrow and slender) blades 11, a high pole 12, an electromagnetic generator 13 on the top of a high pole 12, and a vane 14. The cross section 17 of the conventional blade is shown in FIG. 1: the leading edge 15 of both upper and lower sides is bigger, which may generate higher pressure in front of the edge 15, blocking and reducing the in-coming wind stream. Therefore, that may slow down the incoming wind speed and reduce the air force acting on rotation, and the pointed tail 16 does not aid this problem much.

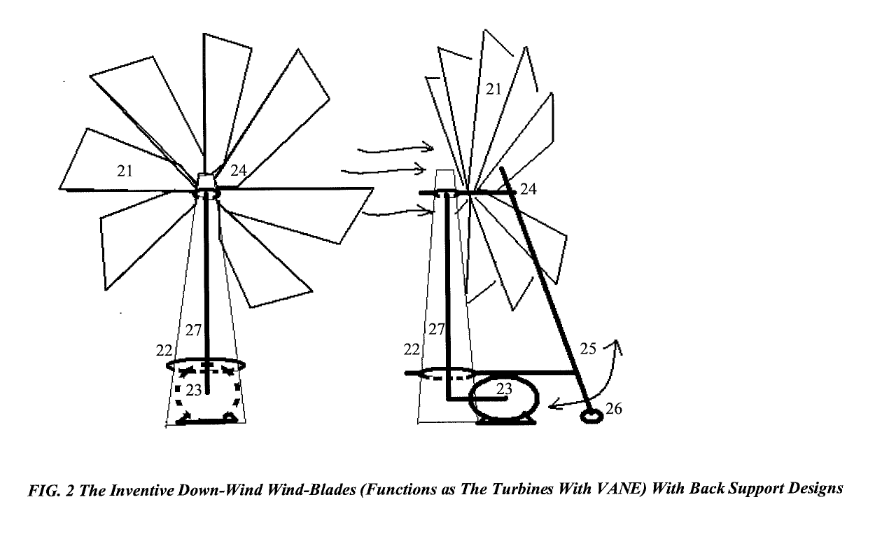

With reference now to FIG. 2, the present new wind turbines power generation processes include multiple large surface area blades 21, central lower pole (mounting member) 22, the power generator 23 mounted on the top of the lower pole, down-wind blades structure (also acting like a vane 24 with a rotational shaft), strong back-supported structure 25, and rolling wheels 26. The conduction cables 27 connect the generator 23 above to the power-generation regulator 28 and other power generation systems 29 like DC/AC converter and transformer mounted on the ground, then tied to the grid. This embodiment of two-phase (or three-phase in rainy or snowing days) turbines 21 uses many large surface area blades 21:

ΣP.ΔA_{Large}=P.[large blade area×many numbers of blades]=F_{Large},

which enables more ambient air's fluctuating energy to be extracted out into a stable electricity through this power generation/discharging regulator 28. The effect is just like charging different numbers of batteries with designated voltages and the output power is from a fixed numbers of batteries through constant voltage output. In one embodiment, the turbines have more than three ‘3’ blades, but it is to be understood that any number of blades could be used, as long as chosen by using sound engineering force and power judgments.

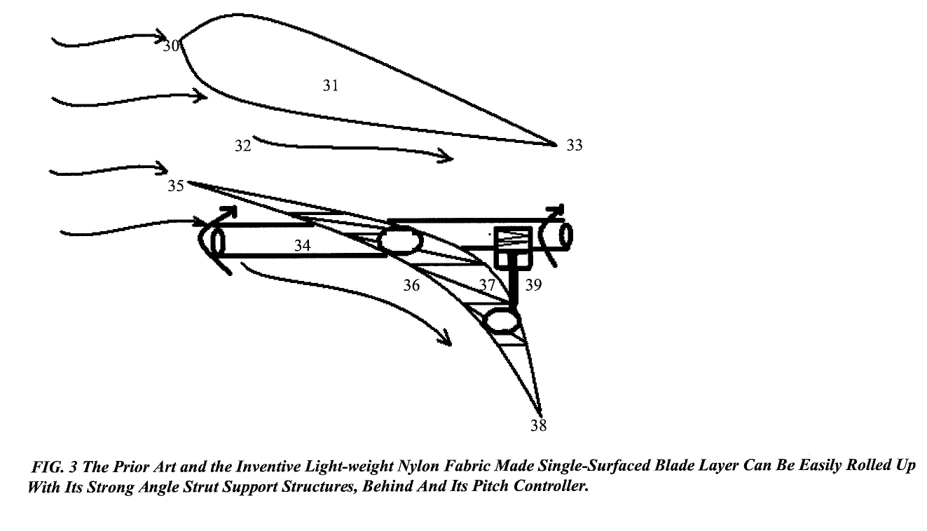

With reference now to FIG. 3, the conventional propeller-like blade's cross section has a bigger leading edge 30 of both upper and lower sides, heavy solid stretched body 31 for avoiding heavy blades from break, and pointed tail-end 33. While wind crosses/attacks the leading edge 30, it is going to generate a higher pressure and more drag force in front of blades. The present invention includes numerous larger reaction surface-area blades mounted on the rotating shaft 34. Each blade has a sharper stream-lined leading edge 35, nylon fabric made single-surfaced blade 36 with strong angled strut support structure body frame 37 behind, and a sharp stream-lined tailing edge 38, which are much lighter than the conventional solid propeller-like blades. It is also easier to control its pitch and its rotation speed through its automatic hydraulic pitch controller 39.

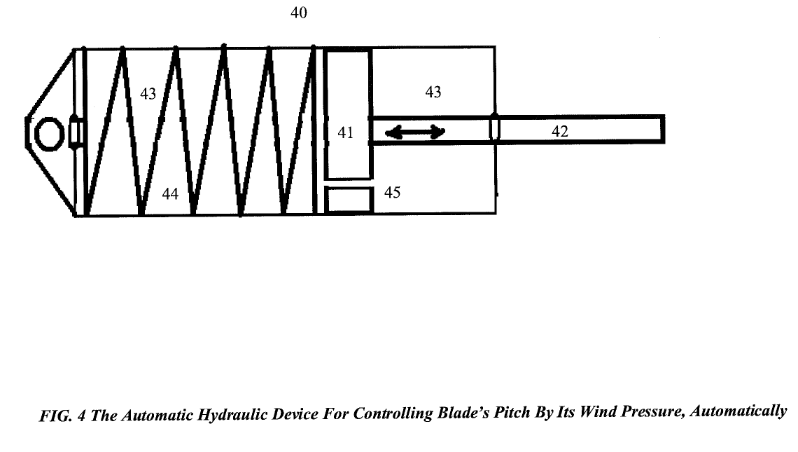

With reference now to FIG. 4, the present new design includes an automatic hydraulic pitch controller 40, which has a piston 41 to balance the strong, but uneven force of changing pitch, sliding shaft 42 to adjust the distance of the pitched blade, hydraulic oil container 43 to reduce the damping effects by its oil's hydraulic pressure, strong spring 44 is forced to change distance by its air/blade's pressure, and oil flows in/out 45 to reduce and balance the blade's pitch damping movements. This automatic-hydraulic pitch controller 40 controls the pitch of the blade in order to control and stabilize the blade speed, blade pressurized rotational force, and the amount of power generation. It is also acted as a safety device to protect the system from constantly stormy attacks. It automatically adjusts the pitch of blade by its uneven strong wind pressure generated at the blade's rear parts if the wind speed exceeds approximately over 50 miles/hr=80 km/hr. However, it is to be understood that any wind speed could be used and desired, as long as chosen by using sound engineering elasticity and force judgments.

In the event of an emergency, the single-surfaced blade layer made of nylon fabric, can be easily rolled up (raise up or lower-down as sails) to close to the central shaft region to avoid hurricanes or for other safety reasons.

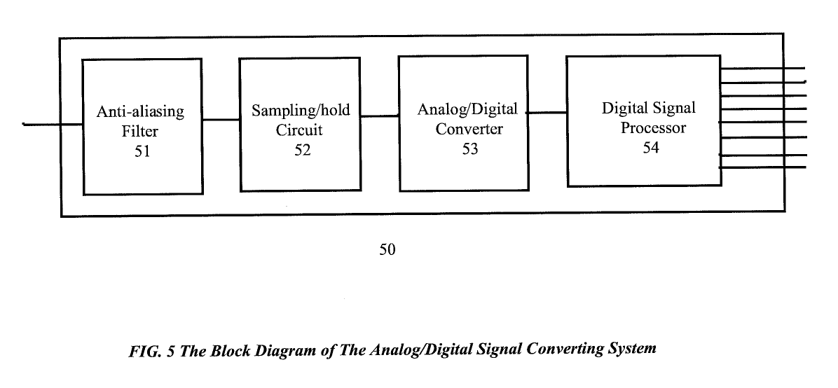

With reference now to FIG. 5, the present invention includes an associate voltage sampler 50, which is composed of an anti-aliasing filter 51, a sampling and hold circuit 52, an analog to digital converter 53, and a digital signal processor 54.

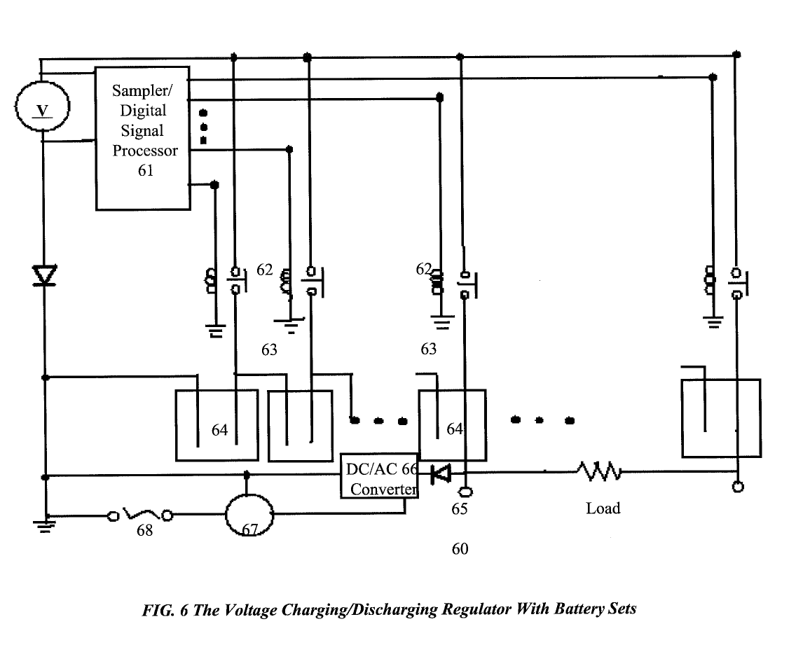

With reference now to FIG. 6, the present invention includes a voltage charging/discharging regulator 60, which is composed of sampler/digital signal processor 61, actuating relays 62, a charging circuitry 63, batteries 64, and a discharging circuitry 65. While an unstable voltage is coming in through this voltage charging/discharging regulator 60, a stable voltage comes out from batteries through a reliable discharging circuitry 65. Then, this electricity output goes to DC/AC converter 66, transformer 67 to elevate its voltage, and then tied to the grid 68.

The high ratio gear reducer (1:1,00=1:10×10 in two stages) increases speed of an associate generator. Turbines are usually used at lower speeds. The high-ratio gear reducer operates the generator at a higher speed. A power-generation regulator stabilizes its power voltage input/output, continuously. The power-generation regulator is mounted on the ground. Its steady output allows the motor and appliances to rotate at a single steady speed and in a more continuous fashion. But the un-steady generator only rotates at speed from 500 rpm to 3,600 rpm. In one embodiment of the invention, the wind turbines have a variable fluctuating rotation speeds of between approximately 5 rpm (at 10 km/hr wind speed; blade's diameter is=10 meters) and approximately 36 rpm (at 72 km/hr wind speed). As long as the speed of the generator is affected by the high efficiency lighter but stronger wind-turbines attached to a higher ratio gear reducer. These wind-turbines generate high-efficiency power from the fluctuating air stream.

But there would be much lower efficiency for conventional methods of generating work from three solid propeller style turbines, which (1): had three blades with much slender and smaller reaction surface areas, and (2): outer rim had to run faster than the wind speed to get the imaginary faster generator speed:

ΣP.ΔAₛₘₐₗₗ=P.[small blade area×fewer numbers of blades]=Fₛₘₐₗₗ=Powerₛₘₐₗₗ.

The outer-portions of blades running faster than wind speed must act like propellers, which must take and waste the power generated from inner-turbines portions(slower than wind speed portions) to run them, inefficiently and wastefully to get more imaginary impractical speed for generator.
Our slow turbines are attached to a gear reducer, which creates a actual-high speed for the generator to generate power. In FIG. 6, the more stable outputs from battery sets increase the power demands' liability and security.

As noted in U.S. Ser. No. 12/195,623, filed on Aug. 21, 2008, the working fluid absorbs heat from the ambient/non-ambient heat sources. This wind power is used to generate electricity through two-phase turbines, whose blades are designed to be durable and balanced to rotate at a slow speed with better stability and less ball-bearing friction. These slow turbines are attached to a high ratio gear reducer to increase its generator's speed and meet its power generation requirements.

The foregoing descriptions of specific innovations of the present invention are presented for purposes of illustration and applications. They are not intended to be exhaustive or to limit the invention to the precise forms disclosed, and obviously many modifications and variations are possible in light of the above disclosure. It is intended that the scope of the invention is defined by the claims appended hereto and their equivalents. Therefore, the scope of the invention is to be limited only by the following claims.

Having thus described the invention, it is now claimed:

1. A method for power generation using wind turbines, wherein the method utilizes down-wind wind turbines, a high-ratio gear reducer to increase a DC generator's speed, an analog/digital voltage converting sampler, a digital signal processor, a power charging/discharging regulator, and power outputs in steady and continuous states to meet its power generation safety and secured requirements, wherein the method comprises the steps of:
generating a pressure difference of air current stream acting on blades;
extracting practical work from the current stream via a nylon fabric made wind turbines;
stabilizing the air's fluctuation-pressure inputs into more stable blade's speeds, continuously via slower-rotating blades;
increasing an associated generator's speed via an associated high-ratio gear reducer; and,
generating a stable high-power DC electricity, continuously through an associated analog/digital converting sampler, a digital signal processor with a battery charging/ discharging regulator, and a steady power output circuit, wherein after extracting wind power, the air current loses its dynamic energy.

2. The method of claim 1, wherein the method further comprises a step of:
automatically adjusting a pitch of the blade by uneven and strong wind pressure generated at the blade's rear parts if wind speed exceeds approximately 50 miles/hr, or 80 km/hr.

3. A low-temperature wind turbine device comprising:
at least three down-wind turbines blades mounted on a top to a lower mounting pole to extract the enough ground wind and save the installation and maintenance costs;
a plurality of fluctuation-pressure stabilizing turbines blades mounted to the top down-wind of the lower pole's;
at least one high ratio gear reducer mounted from a shaft to the generator;
at least one analog/digital voltage converting sampler and a digital signal processor mounted to a battery set in order to be programmed with a battery charging algorithm;
at least one battery power charging/discharging regulator set; and,
at least two cables and circuitry mounted from a generator to at least one battery set;
at least one DC/AC converter, one transformer to step-up its voltage, and a connection to an outside grid.

4. The device of claim 3, wherein the turbine blades have a rotation speed: vₐᵢᵣ=2π.R [rpm/60 sec]=v_{blade's tip}; v_{blade's tip}=vₐᵢᵣ, for maximizing the power production, and the device further comprises:
a hydraulic system for automatically adjusting a pitch of one of the turbines blades from its rear parts.

5. The device of claim 4, wherein the rotation speed v_{blade's tip} of the turbine blades is optimized in accordance with: vₐᵢᵣ=2π.R [rpm/60 sec]=v_{blade's tip}.

6. The device of claim 4, wherein each of the turbines blades has a stream line support structure leading edge, a tailing edge, a top, and a bottom, wherein the blade support structure of an angle strut, between the respective edges, supports a parabolic single-surfaced nylon fabric blade layer, and wherein the respective edges extend beyond the bottom.

7. The device of claim 3, wherein the turbines are two-phase turbines, and wherein a high ratio gear reducer is connected to the two-phase turbines by a rotation shaft.

8. The device of claim 3, wherein a high ratio gear reducer is operatively connected between the turbine and a generator to increase speed of the generator at from about 500 rpm to 3,600 rpm.

9. The device of claim 3, wherein a power generator is operatively connected to a mounting member on the lower pole's top, wherein power cables connect from the power generator to a battery charging/discharging regulator.

10. A wind turbines system comprising:
a pole mounting member;
a power generator operatively connected to the pole mounting member;
a back supporting structure with rotation rollers; and,
a plurality more than three of blades operatively connected to a rotational shaft, wherein the blades have a light-weight, nylon fabric, single-surfaced blade layer, and an angled strut support frame structure.

11. The turbine system of claim 10, wherein the system further comprises:
at least one power charging/discharging regulator connected from a power generator to a battery set by power cables;
at least one high ratio gear reducer mounted on the shaft and connected to the generator; and,
wherein the power generator is at least one associated generator mounted on the lower pole's top, wherein the generator has an air cooled device.

12. The device of claim 10, wherein the turbines are two-phase turbines having a fluctuating rotation speed of between approximately 5 rpm to approximately 36 rpm, and the turbine further comprises:
an automatic hydraulic system capable of adjusting pitches of the blades from the rear parts as their safety devices.

13. The device of claim 11, wherein the gear reducer has a ratio of approximately 1:100=1:10×10 in two stages, and attached to the generator, which has rotation speeds of between 500 rpm to 3,600 rpm.

14. The device of claim 10, wherein the wind turbines power generation system further comprises:
two cables connected from the power generator to a battery power charging/discharging set regulator, wherein an analog/digital voltage converting sampler and a battery charging algorithm circuitry; and,
a steady power output circuitry set for outputting a constant voltage with steady current, continuously tied to the grid.

15. The device of claim 10, wherein the plurality of more than three turbines blades comprises more than three blades, wherein each blade has a stream-lined leading edge of support structure, a tailing edge, a top, and a bottom, wherein the blades, between the support structure edges, have a parabolic stream-lined single-surfaced nylon blade layer, and the edges extend beyond the frame structure of the bottom.
